(19) United States
(12) Patent Application Publication
(10) Pub. No.: US 2012/0002251 A1
(43) Pub. Date: Jan. 5, 2012

(54) Adjustable Reference Guide for an Input Tray of an Imaging Apparatus for Media Sheet Alignment

(76) Inventors: Paul Douglas Horrall, Lexington, KY (US); Philip David Jones, Lexington, KY (US); Franklin Joseph Palumbo, Nicholasville, KY (US)

(21) Appl. No.: 12/827,958

(22) Filed: Jun. 30, 2010

(51) Int. Cl. H04N 1/04

(52) U.S. Cl. 358/498

(57) ABSTRACT

An input tray of an imaging apparatus having an adjustable reference guide for aligning media sheets in the input tray, the reference guide having a first and second reference point defining an axis, the axis being adjustable by one of pivoting of a reference guide wall or moving a slidable plate mounted over a portion of the reference guide allowing for alignment media sheets with one of an image received by the imaging apparatus or a datum axis on the input tray. The adjustments are made during manufacturing or during a servicing operation of the imaging apparatus.

### BACKGROUND OF THE INVENTION

1. Field of the Invention

The present invention relates generally to an input tray of an imaging apparatus and particularly to an input tray of an imaging apparatus having an adjustable reference guide for aligning media in the input tray.

2. Description of the Related Art

An imaging apparatus, such as a printer, a copier, or a multi-function printing device (MFP) typically includes an input tray for supplying media sheets to the imaging apparatus. Each media sheet is picked from the input tray by a pick mechanism of the imaging apparatus to print an image received by the imaging apparatus on the media sheets. Due to variability in loading the media sheets in the input tray as well as dimensional tolerances in the input tray, the media sheets may not be properly aligned to the input tray. This may result in decreased feed reliability of the media sheets, leading to print defects. Further, due to tolerances within other components within the imaging apparatus, such as printhead, etc., the media may not be aligned properly to the image received by the imaging apparatus, leading to additional print defects.

In order to minimize tolerances within the input tray as well as within other components of the imaging apparatus, electronic and/or mechanical adjustments are made in order to properly align the media sheet with the image received by the imaging apparatus or vice versa. These adjustments are made by printing a test pattern on the media sheet and then adjusting the components within the imaging apparatus either electronically, mechanically, or both in order to obtain a properly aligned image on the media sheets. Electronic adjustments may be accomplished by rotating the image received by the imaging apparatus about a fixed point. However, if the image is rotated beyond a threshold limit, print defects may still occur. Mechanical adjustments are made to the other components within the imaging apparatus, such as printheads, etc. However, the components lying within the imaging apparatus are difficult to access and properly adjust. Further, electronic or mechanical adjustments are time consuming and may require multiple iterations.

Thus, there is a need for an imaging apparatus having a media alignment system that is easily accessible, easily applicable, and that eliminates any need to further adjust other components within the imaging apparatus, either electronically or mechanically.

### SUMMARY OF THE INVENTION

Disclosed herein is a reference guide disposed on an input tray of an imaging apparatus to align a media with the input tray.

In one form a reference guide disposed on an input tray of an imaging apparatus to align a media, the reference guide comprises a first portion having a first reference point; and a second portion having a second reference point, the second reference point being movable relative to the first reference point such that an axis drawn between the first reference point and the second reference point is perpendicular to one of a datum axis drawn between two reference datums of the input tray and to the image received by the imaging apparatus, thereby aligning the media in contact with the first and second portions of the reference guide.

The first portion of the reference guide forms a reference side wall extending therefrom, the reference side wall having a pivotable mount on the first portion of guide adjacent the first reference point, and an adjustment device provided on the second portion of the reference guide adjacent at the second reference point wherein movement of the adjustment devices pivots the reference side wall. At least one biasing member biases the media against the reference guide, the at least one biasing member being mounted on an opposing side wall of the input tray opposing the reference side wall. The reference guide and the opposing side wall are movable relative to one another such that the opposing side wall is moveable into a parallel orientation with the reference side wall. further a distance between the reference side wall and the opposing side wall is adjustable to one or more predetermined distances to accommodate a range of media sizes.

In one form the adjustment device is a screw in contact with the reference side wall.

The axis drawn between the first reference point and the second reference point extends substantially parallel to a feed direction of the media during printing and the datum axis may be substantially perpendicular to a feed direction of the media during printing.

In a further form the first portion of the reference guide forms a side wall extending therefrom having the first reference point thereon and the reference guide further comprises an adjustable plate slidably mounted on the second portion of the reference guide, the adjustable plate having a vertical wall extending therefrom and having the second reference point thereon wherein movement of the adjustable plate moves the axis between the first and second reference points, the adjustable plate slidable in a direction transverse to a feed direction of the media; and a fastener for fastening the adjustable plate to the second portion of the reference guide upon completion of aligning the media.

In other forms, the invention is an input tray for holding media for an imaging apparatus comprising: a base surface; a first wall extending upwardly from the base surface, the first wall having a pair of spaced apart reference datums defining a datum axis drawn between said pair of reference datums, said datum axis being transverse to a feed direction of the media; a reference guide assembly slidably mounted on the base, an opposing side wall opposing the reference side wall, the opposing side wall being slidably mounted on the base surface, and at least one biasing member mounted on an opposing side wall to bias the media against the reference side wall.

In yet further forms, the reference guide assembly comprises a reference guide extending between a first portion having a first reference point and a second portion having a second reference point; a portion of the reference guide forming a reference side wall extending upwardly from the first portion, the reference side wall being pivotally mounted at the first reference point and extending to the second reference point; and an adjustment device mounted on the second portion adjacent the second reference point, the adjustment device pivotally moving the reference side wall about the first reference point to align the reference side wall one of the datum axis and an image received by the imaging apparatus.

Again in other embodiments, the reference side wall and the opposing side wall are movable relative to the base surface input tray and with respect to one another with the opposing side wall being further moveable and fixable into parallel alignment with the reference side wall after the reference side wall is aligned. A distance between the reference side wall and the opposing side wall is adjustable to one or more predetermined distances to accommodate a range of media sizes. The axis drawn between the first reference point and the second reference point extends parallel to the feed direction of the media and the datum axis drawn between the two reference datums of the input tray is perpendicular to the feed direction of the media.

In a still further form, an input tray for an imaging apparatus comprises: a base surface; a reference guide assembly mounted on the base surface to align a media, and an opposing sidewall opposing the reference guide and having at least one biasing member mounted thereon to bias the media against the reference guide, the opposing side wall being mounted on the base surface. The reference guide assembly comprises: a reference guide extending between a first portion and a second portion, the first portion having a first reference point; and an adjustable plate mounted on the second portion of the reference guide and having a second reference point thereon, the first and second reference points defining an axis, the adjustable plate being movable relative to the second portion of the reference guide in a direction substantially perpendicular to a feed direction of the media so as to move the alignment of the axis with respect to the feed direction of the media.

In other embodiments, at least a portion of the reference guide assembly forms a reference side wall of the input tray. The reference side wall and the opposing side wall are movable relative to the input tray. The opposing sidewall and reference guide are moveable with respect to one another and are adjustable to one or more predetermined distances to accommodate a range of media sizes. The input tray may further comprise a first side wall and a second side wall, each extending upwardly from the base surface, the first and the second side wall being substantially parallel to the feed direction of the media, the first and the second side wall being fixed with respect to the base surface and wherein a distance between the first side wall and the second side wall is greater than a distance between the opposing side wall and the reference guide assembly.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 illustrates a top perspective view of one embodiment of an input tray for an imaging apparatus according to the present invention;

FIG. 2 is a top elevational view of one embodiment of a reference guide according to the present invention used with the input tray of FIG. 1;

FIG. 3 is a top elevational view of another embodiment of a reference guide assembly according to the present invention showing a position of an adjustable plate on the reference guide; and

FIG. 4 is a top elevational view of a portion of the reference guide assembly of FIG. 3 showing another position of the adjustable plate on the reference guide.

### DETAILED DESCRIPTION

Reference will now be made in detail to the exemplary embodiment(s) of the invention as illustrated in the accompanying drawings. Whenever possible, the same reference numerals will be used throughout the drawings to refer to the same or like parts.

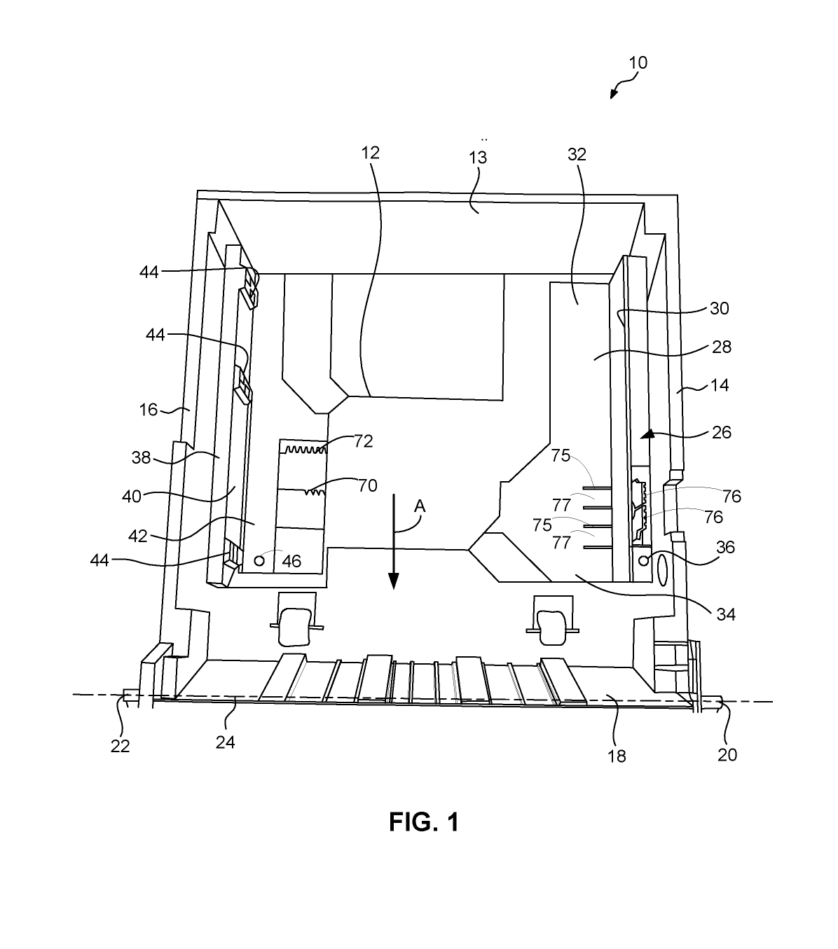

FIG. 1 illustrates a top perspective view of an input tray 10 for use with an imaging apparatus (not shown). Input tray 10 has a base surface 12 for supporting a stack of media sheets, a first side wall 14, a second side wall 16, and a first wall 18. First side wall 14, second side wall 16, and first wall 18 extend vertically up from base surface 12 and are fixed with respect to base surface 12. Input tray 10 may also include a second wall 13. First and second walls 18, 13 are transverse to a feed direction of the media. First and second walls 18, 13 may be termed rear wall and front wall respectively. It should be realized that the terms “front” and “back” as applied to the walls 18, 13 are relative terms and may be interchanged without affecting the scope of the invention. Walls 13, 14, 16 and 18 can be joined together, can be freestanding, or joined in other combinations as would be known to one of ordinary skill in the art without affecting the scope of the invention.

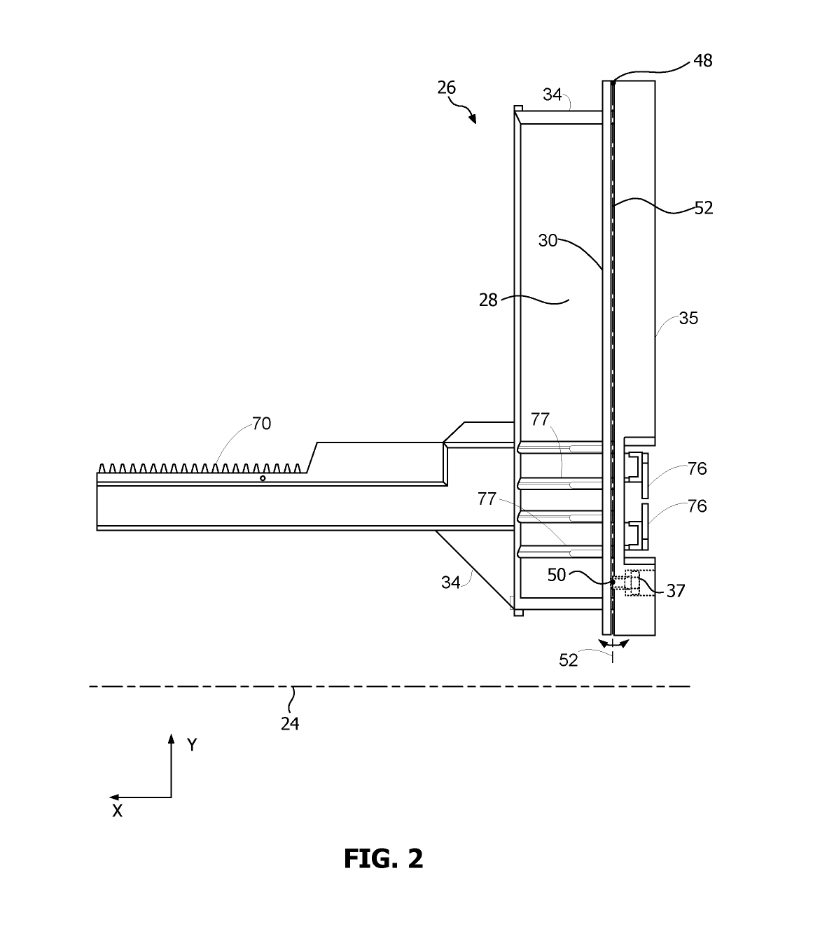

Two reference datums 20, 22 are located at two edges of first wall 18 of input tray 10 and form a datum axis 24 of input tray 10. Datum axis 24, formed by a line between the two reference datums 20, 22 of input tray 10, provides a reference line for aligning the media sheets to input tray 10, thereby ensuring minimization of dimensional tolerances within input tray 10 as will be discussed with respect to FIG. 2. A feed direction of the media sheet (shown by arrow A), i.e., the direction in which the media sheet moves during printing operation, is perpendicular to datum axis 24 of input tray 10.

Input tray 10 further includes a reference guide 26 slidably mounted on base surface 12 that lies adjacent to first side wall 14 of input tray 10. A horizontal portion 28 of reference guide 26 rests over base surface 12 while a vertical portion of reference guide 26 that forms a reference side wall 30 extends vertically up relative to base surface 12. Horizontal portion 28 of reference guide 26 extends between a first portion 32 and a second portion 34, first portion 32 lying near one end of reference guide 26 and second portion 34 lying near the other end of reference guide 26. Second portion 34 further includes an adjusting feature 36 for adjusting the alignment of reference side wall 30 with respect to a media alignment reference such as datum axis 24.

Input tray 10 also includes an opposing side wall 38 that lies adjacent to second side wall 16. A vertical portion 40 of opposing side wall 38 is perpendicular to base surface 12, while a horizontal portion 42 of opposing side wall 38 is slidably mounted over base surface 12. A plurality of biasing members 44 are disposed on vertical portion 40 of opposing side wall 38 that bias the media sheets against reference side wall 30. The plurality of biasing members 44 can be viewed as a plurality of parallel spring elements that are vertically aligned along the height of vertical portion 40 in an overlapping manner so that each biasing member only acts against a small portion of the total media stack height. As media sheets are removed from the stack and the media stack height is lowered, the lower positioned biasing members act upon their respective portions of the stack to move the media against reference side wall 30. The plurality of biasing members 44 can be made up of materials including spring, rubber, foam, or any other suitable resilient material. When the media sheets are placed in input tray 10, one side of the media sheets comes in contact with the plurality of biasing members 44 such that the other side of the media sheet is biased against reference side wall 30. Opposing side wall 38 may also have a pivoting feature 46 to allow its alignment to be adjusted with respect to reference side wall 30.

Both reference guide 26 and opposing side wall 38 are movable over base surface 12 such that a distance between opposing side wall 38 and reference side wall 30 is adjustable to one or more predetermined distances in order to accommodate for a range of media sheet sizes. One or more L-shaped cantilevered levers 75, as illustrated two levers 75, are cut into second portion 34 of horizontal portion 28. The upper portions 76 of L-shaped levers 75 extend upwardly in a direction generally parallel to reference side wall 30. The lower surface of lower portion 77 of each of levers 75 engage a corresponding serrated strip molded into base surface 12. Pinching upper portions 76 of levers 75 toward reference side wall 30 releases their engagement with the serrated strips allowing reference side wall 30 and opposing side wall 38 to be adjusted.

Reference side wall 30 and either opposing side wall 38 or the plurality of biasing members 44 are preferably positioned substantially parallel to each other. Exact parallelism is not required. In a further embodiment opposing side wall 38 or vertical portion 40 of opposing side wall 38 made be provided with a pivotable mount for pivotal adjustment with respect to reference side wall 30 to allow for the parallel alignment with reference side wall 30. Alternatively or in combination with the pivotable opposing side wall 38 or vertical portion 40, at least a portion of the plurality of biasing members 44 may be pivotally mounted in vertical portion 40 for pivotal adjustment with respect to reference side wall 30 to allow for parallel alignment with reference side wall 30. After opposing side wall 38 and reference guide 26 are adjusted with respect to base surface 12, they are slidably mounted to base surface 12 using, for example racks 72 and 70, respectively, which engage a pinion (not shown) mounted to base surface 12, as is known in the art. The media sheets are disposed between opposing side wall 38 and reference side wall 30.

According to one embodiment of the present invention, first side wall 14 and second side wall 16 may be optional, and reference side wall 30 and opposing side wall 38 act as first side wall 14 and second side wall 16, respectively, of input tray 10. Input tray 10 may further include additional features for mounting input tray 10 to the imaging apparatus. Input tray 10 may be removable from the imaging apparatus for refilling from time to time.

As discussed above, the media sheets may be misaligned with respect to input tray 10, or may also be misaligned with respect to the image received by the imaging apparatus. According to one embodiment of the present invention, when the media sheet is misaligned with respect to input tray 10, then reference side wall 30 is adjusted relative to reference guide 26 in order to align the media sheets to datum axis 24 of input tray 10 as shown in FIG. 2. It will be realized that the embodiment shown in FIG. 2 can also be used to when the media sheets may be misaligned with respect to the image received by the imaging apparatus.

FIG. 2 shows a top elevational view of reference guide 26 illustrating horizontal portion 28 of reference guide 26 substantially extending along the length of vertical reference side wall 30. Reference side wall 30 has a first reference point 48 about which is pivotably rotatable and a second reference point 50. As illustrated reference side wall 30 is pivotally attached to support 35 which is shown having a length and height similar to that of reference side wall 30. When the manufacturer or the service provider moves second reference point 50 such as for example by rotating screw 37 that is mounted on support 35 of reference guide 26 relative to first reference point 48, reference side wall 30 pivots about first reference point 48 to align the media sheet either to datum axis 24 in input tray 10 or to align the media sheet to the image received by the imaging apparatus.

An axis 52 of reference guide 26 is formed by a line between first reference point 48 and second reference point 50. The use of screw 37 to adjust reference side wall 30 permits fine continuous adjustment in the alignment of the media sheet until the desired alignment is achieved. The end of screw 37 can be attached to reference side wall 30 by various means as is known in the art such as use of an adhesive or having a nut countersunk into the surface of reference side wall 30. Reference side wall 30 is then held in position by screw 37. Reference side wall 30 can be adjusted to pivot toward and away from support 35. The pivotal adjustment typically needed for aligning reference side wall 30 is small, for example, ±0.5 degrees. Some adjustments have been ±0.13 degrees. Support 35 can be continuous between the reference points 48, 50 or can be replaced by having a pivot pin at reference point 48 and a support post to hold the adjustment device at reference point 50. Other variations can also be used as would be known of one of ordinary skill in the art.

Due to the pivoting of reference side wall 30, it may no longer be parallel to opposing side wall 38. Thus, following the alignment of reference side wall 30, opposing side wall 38 or a portion of the plurality of biasing members 44 or both can be adjusted to be parallel to reference side wall 30. This way opposing side wall 38 is properly aligned with respect to reference side wall 30 such that plurality of biasing members 44 of opposing side wall 38 contact the one side of the media sheets and bias the other side of the media sheets against reference side wall 30.

According to the embodiments of the present invention, as an alternative to aligning the media sheet to input tray 10, adjustments are made within input tray 10 such that the media sheets are aligned to the image received by the imaging apparatus.

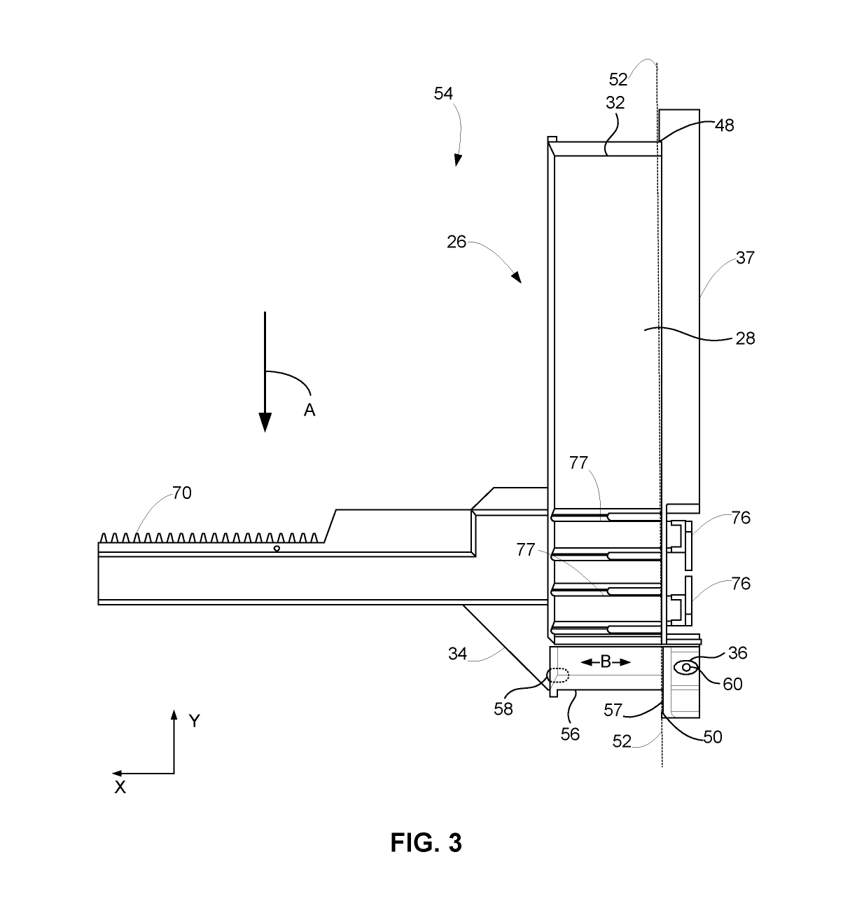

FIG. 3 shows a top elevational view of a reference guide assembly 54 on input tray 10 having reference guide 26 and an adjustable plate 56. Reference guide 26 includes first portion 32 having a vertically extending wall 37 having reference point 48 located at a corner thereof. An adjustable plate 56 is mounted on and slidably adjustable with respect to second portion 34 and wall 37. Adjustable plate 56 is mounted on a slot 58 in second portion 34 of reference guide 26. Adjustable plate 56 has a vertical wall 57 extending upwardly therefrom having reference point 50 located at a corner thereof. Axis 52 extends between reference points 48 and 50. As adjustable plate 56 moves in slot 58, reference point 50 shifts with respect to reference point 48 causing axis 52 to shift providing for aligning the media sheet either to the image received by the imaging apparatus or with respect to datum axis 24.

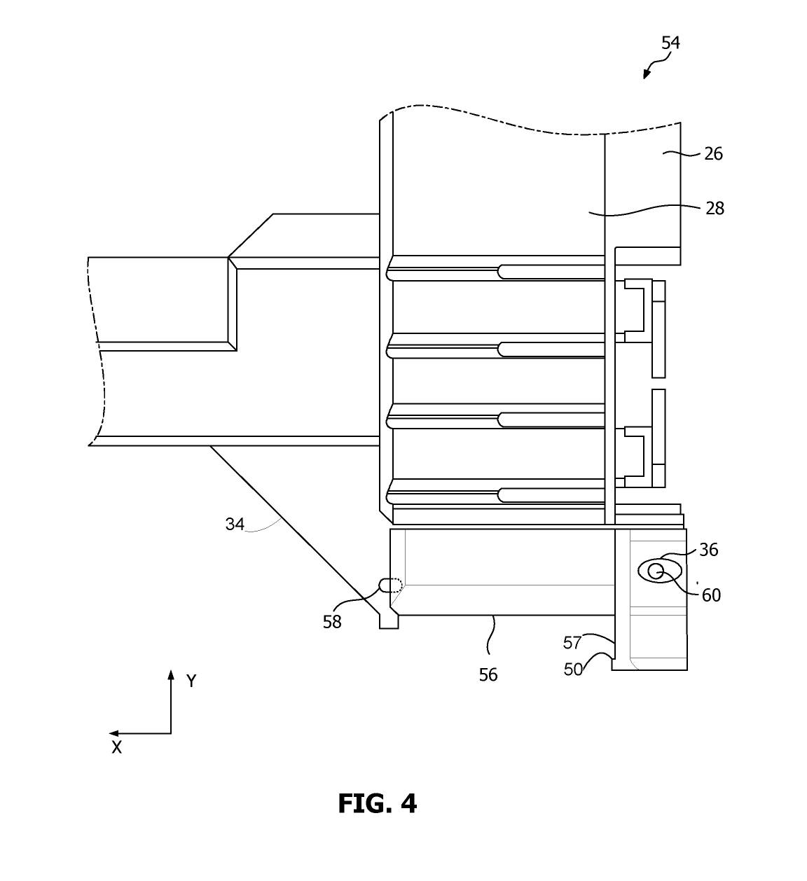

Adjustable plate 56 is movable along slot 58 relative to second portion 34 of reference guide 26 in a direction that is substantially perpendicular to the feed direction (shown by double headed arrow B) of the media sheet during printing (shown by the arrow A), i.e., along the X-axis direction. It has been found that allowing adjustable plate 56 to have an overall travel of about 5 mm will be sufficient for aligning reference guide 26. FIG. 3 shows a position of adjustable plate 56 on reference guide 26 where a fastening point 60 of adjustable plate 56 is located at the center of fastening feature 36 of the second portion 34 of reference guide 26, thereby a small portion of slot 58 being visible. FIG. 4 shows a different position of adjustable plate 56 on reference guide 26 where adjustable plate 56 has been moved in X-axis direction such that fastening point 60 of adjustable plate 56 has moved to a left end of fastening feature 36 of reference guide 26, thereby a relatively larger portion of slot 58 being visible. In this way, adjustable plate 56 moves relative to second portion 34 of reference guide 26 pivoting axis 52 about reference point 48 aligning the media sheet to the image received by the imaging apparatus or to datum axis 24. After adjustable plate 56 is adjusted along slot 58, adjustable plate 56 is rigidly fastened to reference guide 26 by inserting a screw or any other fastening mechanism at fastening point 60 of adjustable plate 56 into second portion 34 of reference guide 26. With this arrangement adjustable plate 56 may be moved and then fixed in place while allow reference 26 to remain adjustable to accommodate various widths of media.

In order to determine whether the media sheets has been aligned to the image received by the imaging apparatus, the manufacturer or in some cases the service provider, after repairing or replacing one or more component of the imaging apparatus, takes a print out of the image on a media sheet. If it is determined that the image has been properly aligned with respect to the media sheet, adjustable plate 56 is no more adjusted. However, if it is determined that the image is not properly aligned to the media sheet, adjustable plate 56 is moved along slot 58 again relative to second portion 34 of reference guide 26 before adjustable plate 56 is fixed once again to reference guide 26. Thereafter, a print out of the image is taken once again to determine whether the image has now been aligned to the media sheet. This process is repeated until the manufacturer or the service provider determines that the media sheet is aligned to the image received by the imaging apparatus. A similar process can be used with pivotable reference wall 30 shown in FIG. 2.

As the media sheets are aligned by making adjustments within input tray 10 of the imaging apparatus, it is easily accessible by the manufacturer or the service provider and also easy for them to align the media sheets during assembly process, in contrast to adjusting other components within the imaging apparatus. It will be apparent to those skilled in the art that various modifications and variations can be made to the present invention without departing from the spirit and scope of the invention. Thus, it is intended that the present invention cover the modifications and variations of this invention provided they come within the scope of the adapted claims and their equivalents.

What is claimed is:

1. A reference guide disposed on an input tray of an imaging apparatus to align a media, the reference guide comprising:
a first portion having a first reference point; and
a second portion having a second reference point, the second reference point being movable relative to the first reference point such that an axis drawn between the first reference point and the second reference point is perpendicular to one of a datum axis drawn between two reference datums of the input tray and to the image received by the imaging apparatus, thereby aligning the media in contact with the first and second portions of the reference guide.

2. The reference guide of claim 1, wherein the first portion of the reference guide forms a reference side wall extending therefrom, the reference side wall having a pivotable mount on the first portion of guide adjacent the first reference point, and an adjustment device provided on the second portion of the reference guide adjacent at the second reference point wherein movement of the adjustment devices pivots the reference side wall.

3. The reference guide of claim 2, wherein at least one biasing member biases the media against the reference guide, the at least one biasing member being mounted on an opposing side wall of the input tray opposing the reference side wall.

4. The reference guide of claim 3, wherein the reference guide and the opposing side wall are movable relative to one another such that the opposing side wall is moveable into a parallel orientation with the reference side wall.

5. The reference guide of claim 3, wherein a distance between the reference side wall and the opposing side wall is adjustable to one or more predetermined distances to accommodate a range of media sizes.

6. The reference guide of claim 2, wherein the adjustment device is a screw in contact with the reference side wall.

7. The reference guide of claim 1, wherein the axis drawn between the first reference point and the second reference point extends substantially parallel to a feed direction of the media during printing.

8. The reference guide of claim 1, wherein the datum axis is substantially perpendicular to a feed direction of the media during printing.

9. The reference guide of claim 1, wherein the first portion of the reference guide forms a side wall extending therefrom having the first reference point thereon and the reference guide further comprises:
an adjustable plate slidably mounted on the second portion of the reference guide, the adjustable plate having a vertical wall extending therefrom and having the second reference point thereon wherein movement of the adjustable plate moves the axis between the first and second reference points, the adjustable plate slidable in a direction transverse to a feed direction of the media; and
a fastener for fastening the adjustable plate to the second portion of the reference guide upon completion of aligning the media.

10. An input tray for holding media for an imaging apparatus, the input tray comprising:
a base surface;
a first wall extending upwardly from the base surface, the first wall having a pair of spaced apart reference datums defining a datum axis drawn between said pair of reference datums, said datum axis being transverse to a feed direction of the media;
a reference guide assembly slidably mounted on the base, the reference guide assembly comprising:
a reference guide extending between a first portion having a first reference point and a second portion having a second reference point;
a portion of the reference guide forming a reference side wall extending upwardly from the first portion, the reference side wall being pivotally mounted at the first reference point and extending to the second reference point; and
an adjustment device mounted on the second portion adjacent the second reference point, the adjustment device pivotally moving the reference side wall about the first reference point to align the reference side wall one of the datum axis and an image received by the imaging apparatus;
an opposing side wall opposing the reference side wall, the opposing side wall being slidably mounted on the base surface, and
at least one biasing member mounted on an opposing side wall to bias the media against the reference side wall.

11. The reference guide of claim 10, wherein the reference side wall and the opposing side wall are movable relative to the base surface input tray and with respect to one another with the opposing side wall being further moveable and fixable into parallel alignment with the reference side wall after the reference side wall is aligned.

12. The reference guide of claim 11, wherein a distance between the reference side wall and the opposing side wall is adjustable to one or more predetermined distances to accommodate a range of media sizes.

13. The reference guide of claim 10, wherein the axis drawn between the first reference point and the second reference point extends parallel to the feed direction of the media.

14. The reference guide of claim 10, wherein the datum axis drawn between the two reference datums of the input tray is perpendicular to the feed direction of the media.

15. An input tray for an imaging apparatus, the input tray comprising:
a base surface;
a reference guide assembly mounted on the base surface to align a media, the reference guide assembly comprising:
a reference guide extending between a first portion and a second portion, the first portion having a first reference point; and
an adjustable plate mounted on the second portion of the reference guide and having a second reference point thereon, the first and second reference points defining an axis, the adjustable plate being movable relative to the second portion of the reference guide in a direction substantially perpendicular to a feed direction of the media so as to move the alignment of the axis with respect to the feed direction of the media;
and
an opposing sidewall opposing the reference guide and having at least one biasing member mounted thereon to bias the media against the reference guide, the opposing side wall being mounted on the base surface.

16. The input tray of claim 15, wherein at least a portion of the reference guide assembly forms a reference side wall of the input tray.

17. The input tray of claim 15, wherein the reference side wall and the opposing side wall are movable relative to the input tray.

18. The input tray of claim 15, wherein the opposing sidewall and reference guide are moveable with respect to one another and are adjustable to one or more predetermined distances to accommodate a range of media sizes.

19. The input tray of claim 15, further comprising a first side wall and a second side wall, each extending upwardly from the base surface, the first and the second side wall being substantially parallel to the feed direction of the media, the first and the second side wall being fixed with respect to the base surface and wherein a distance between the first side wall and the second side wall is greater than a distance between the opposing side wall and the reference guide assembly.
